(19) United States
(12) Patent Application Publication
(10) Pub. No.: US 2012/0198923 A1
(43) Pub. Date: Aug. 9, 2012

(54) METAL LOSS PROBE AND METHOD FOR FABRICATING THE METAL LOSS PROBE

(75) Inventors: Henry Alan Wolf, Morristown, NJ (US); Alan Mark Schilowitz, Highland Park, NJ (US); James E. Feather, Fairfax, VA (US); Manuel S. Alvarez, Warrenton, VA (US)

(73) Assignee: EXXONMOBIL RESEARCH AND ENGINEERING COMPANY, Annandale, NJ (US)

(21) Appl. No.: 13/362,624

(22) Filed: Jan. 31, 2012

Related U.S. Application Data
(60) Provisional application No. 61/439,532, filed on Feb. 4, 2011.

(51) Int. Cl. G01N 17/00; B23K 11/00; B23K 20/00

(52) U.S. Cl. 73/86; 228/101; 219/148

(57) ABSTRACT

The present invention describes the connecting of a corrodible material with a non-corrodible material by electron beam welding so that the corrodible material is not affected by non-corrodible material during the welding process. Employing an electron beam welding process not only minimizes unintended alloying of the corrodible element but also minimizes the width of the weld heat affected and fusion zones. This fabrication method is necessary to ensure that the corrodible element faithfully replicates the wastage of the subject metal.

### CROSS REFERENCE TO RELATED APPLICATIONS

This application relates and claims priority to U.S. Provisional Patent Application No. 61/439,532 entitled “A Metal Loss Probe and Method for Fabricating the Metal Loss Probe” filed on Feb. 4, 2011.

### BACKGROUND OF THE INVENTION

The present invention relates to a metal loss corrosion and/or erosion probe and a method for the fabrication of the metal loss probe. The fabrication includes a welding step.

The present invention specifically relates to a metal loss measurement probe for the detection of corrosion and for measuring the rate of metal mass loss. The invention may be applied generally to the detection of metal-loss by corrosion and/or erosion species in single or multiphase fluids. In particular, the present invention relates to the on-stream detection of metal-loss corrosion and/or erosion during an industrial production process. The actual service environment may be aqueous, hydrocarbon, chemical or a combination.

Corrosive or erosive species involved in the production and processing of crude oil and hydrocarbons may cause metal-loss of production, transfer, storage, and processing equipment. Erosion typically involves fluid and/or solids turbulence causing metal loss from mechanical actions rather than chemical. For example, these corrosive/erosive species may be hydrocarbon, hydrocarbon containing materials, or aqueous, or combinations thereof. Moreover, streams may be single or multi-phase (solids, liquids, gases).

High performance, relatively low-cost corrosion (erosion) sensing technology as in the present invention would enable, for example, optimized utilization of corrosive crudes and corrosion inhibitor additions, and reductions in unplanned capacity loss, turnaround time, and inspection costs due to corrosion-induced equipment failures. Additional value is achievable with the application of the present invention to corrosion monitoring of transfer, process, and storage equipment used for crude oil, fractions and derived products, and chemicals and other industries concerned with corrosion and erosion. Further value is achievable with the application to monitoring metal-loss corrosion in equipment used for the extraction of crude oil from subsurface and subsea deposits. In these and other services, a by-product of corrosion may be scale or other depositions that are adherent to the containment surface. A feature of the present invention is that the metal loss measurement is not compromised by these non-metallic depositions.

Current corrosion/erosion sensing technologies, for example electrical resistance probes, fail far short of the performance level required to achieve the economic incentives described above. One limitation relates to sensitivity versus useful sensor life. Increasing sensitivity of the conventional electrical resistance probe is achieved by decreasing the thickness of the sensing element. However, the decrease in thickness results in a reduced life of the probe. Once corrosion results in a breach of the element, the probe will no longer function and must be replaced. In an operating process unit, on-stream probe replacement poses various safety and hazard issues. Another limitation of the electrical resistance probes relates to their inherent signal variability. The signal variability caused by thermal changes and other factors that affect electrical resistance necessitate long data collection periods (often a week or longer) to establish a reliable trend. While conventional electrical resistance probes are based on understood theoretical principals, these probes often provide low reliability and poor sensitivity to corrosion rates due to limitations in their design and manufacture. The typical output is often difficult for estimating a reliable quantitative corrosion rate.

The design of most metal loss probes typically employs materials that are compatible with the service fluid as well as materials that will corrode. For cases where the materials are metallic, typically some sort of welding joining technology will be used. The metal loss probe that is fabricated herein is described in U.S. Pat. No. 7,681,449 The probe requires the welded joining of a corrodible to a non-corrodible element. The probe is a mechanical oscillator metal loss sensor used in a corrosive or erosive environment. The probe includes a mechanical oscillator with two regions that corrode differently. The mechanical oscillator is mechanically or electrically excited, and the regions are determined to affect specific influences on the resonance parameters. The mechanical oscillator has a resonant frequency, f, and a quality factor, Q. In a preferred embodiment, the mechanical oscillator has the shape of a tuning fork.

### SUMMARY OF THE INVENTION

The present invention includes a metal loss probe with two materials welded together that will be used in a corrosive or erosive environment.

The two materials interact differently in the corrosive/erosive environment. For example, in a corrosive environment, one of the materials, e.g. carbon steel will corrode. The other material, e.g. austenic stainless steel, does not corrode. In the erosive environment, one of the metals will be selected to minimize erosion. In some cases it may be necessary to provide a protective coating to the metal material that is not intended to be wasted.

In a preferred embodiment, the two materials form a mechanical oscillator metal loss sensor to determine the metal loss in the corrosive or erosive environment. To preserve the desired mechanical resonating properties of the oscillator, such as frequency and quality factor, the two materials must be securely joined by welding. The method of welding must not alter the metal loss response of the materials to the corrosive or erosive environment. This non-altering step is achieved by a welding process that localizes the heat to minimize the spatial extent of the weld heat affected zone. Electron beam welding is one example of an applicable welding methodology. Electron beam welding has the capability of achieving a single-pass full penetration weld and yet it minimizes the width of the weld heat affected zone. Although laser welding can achieve a smaller heat affected zone compared to traditional tungsten arc welding, electron beam welding is even more localized. The electron beam weld has the added complexity that it must be performed in a vacuum to maximize its beneficial properties. That added complexity has the benefit of reducing atmospheric contamination.

In most applications where two dissimilar metals are being joined, welding procedures may provide some enhanced corrosion protection of the lower alloy material. Alloy dilution across the weld is frequently controlled in a way to achieve this objective. This invention teaches away from that possibility. In this invention, the weld procedure is devised to maintain the corrodibility of the material on the low alloy side of the weld. This result is achieved by minimizing alloy dilution, splatter from filler metal, and the extent of the heat affected zone.

### BRIEF DESCRIPTION OF THE DRAWINGS

For a better understanding of aspects of the invention, reference should be made to the Description of the Preferred Embodiment below, in conjunction with the following figures in which like reference numerals refer to like elements throughout the figures.

FIG. 1 shows the locations of the welds in the mechanical metal loss detector oscillator in accordance with an aspect of the present invention.

FIG. 2 shows a fixture for holding component parts to prepare for the electron beam welding process.

FIG. 3 shows a schematic of an optical microscope image of the welded corrodible element fabricated with electron beam welding.

FIG. 4 shows a schematic of an optical microscope image of the welded corrodible element fabricated with a method other than electron beam welding.

### DESCRIPTION OF THE PREFERRED EMBODIMENT

The present invention identifies the importance of applying the correct method to welding the corrodible element in a corrosion/erosion sensor for use in a corrosive liquid or gas environment.

In a preferred embodiment, the sensor includes a mechanical oscillator. The oscillator has a vibrating element such as tuning fork tines. As examples, the cross-sectional shape of the tines or rod may be circular, rectangular, or as otherwise determined by finite element analysis. These vibrating elements are attached to a diaphragm. The vibrating elements (e.g. tines or rod) have regions that respond to the corrosive/erosive environment at different metal loss rates. The vibrating element includes a stem (base) and a tip region. In the examples presented, the stem (base) section is fabricated from a material that provides the represented rate of metal loss for the service fluid. The tip region material or protective coating is designed to be compatible (e.g. will not corrode/erode) with the service fluid.

The tuning fork or rod has two regions of differing corrosion resistance. Regions of differing corrosion resistance include one of the regions that does not corrode at all. Both regions are subjected simultaneously to the corrosive environment.

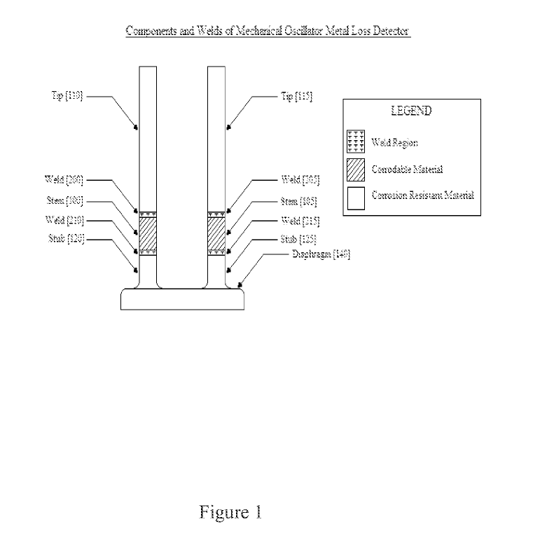

FIG. 1 shows one configuration for the position of the elements and the locations of the welds for a tuning fork of the present invention. The corrodible element (the stem 100, 105) for the tuning fork corrosion probe is welded in the tine between the tip 110, 115 and the stubs 120, 125. The corrodible stern 100, 105 is approximately 6 mm in length. In a preferred embodiment, stubs 120, 125 are fabricated as part of the diaphragm structure as a cast or machined product. Therefore, in that case, there is no weld to attach the stubs to the diaphragm. The tine is the fully assembled structure of the tip, stem, and stub. Typically, all the materials of the wetted elements of the tuning fork corrosion probe (except the corrodible stem) are high alloy materials compatible with the process fluid. If welds 200, 210, 205, 215 are made using excessive heat, dilution of alloying material from the high alloy elements will change the chemistry of the corrodible elements. The welds are approximately 1 mm laterally. Chemical and mechanical hardness changes will effectively modify the corrodible element preventing the stem from corroding in the anticipated manner. Excessive heat may also cause distortion of the diaphragm 140, stub 120, stem 100, or tip 110. In addition to distortion, heat may also damage electrical internals attached to the backside of the diaphragm such as piezo electric crystals. It is typically desirable to have the corrosion properties of the stem element mimic the properties of the susceptible pressure containing components (pipes, vessels, etc.) as realistically as possible. If an arc welding joining method is used, the high alloy filler metal may splatter and thereby change the corrosive/erosive character of the stem material.

The high intensity and highly localized beam produced for electron beam welding minimizes contamination and changes of the base metal compared to other welding methods. Electron beam and laser welding are high power density processes that vaporize the metal interfaces of the work piece. In electron beam welding, power density, measured in ‘Watts/cm’, is the product of beam voltage and current measured in a specified area at right angle to the beam axis. These methods allow heat to be deposited subsurface enabling full penetration welds. The primary advantage of electron beam welding is that deep penetrating welds can be produced with minimal impact in the surrounding material. Another advantage of electron beam welding is that it enables the joining of two very dissimilar metals.

Full penetration welds have two primary advantages for the fabrication of metal loss sensors. First, they enable a longer survival time for the probe. With full penetration, there is increased metal available as the probe corrodes/erodes. Secondly, full penetration adds to the rigidity of the tines in the mechanical oscillator metal loss sensor embodiment. Increasing rigidity adds stiffness and results in a higher quality factor associated with the system mechanical resonance. This higher quality factor improves the sensitivity of measuring the resonance frequency and identifying a frequency change that would be indicative of metal loss.

The quality of the weld is dependent upon the beam's power density. Power density, weld quality, and alloy diffusion will be dependent upon beam focus, beam current, travel speed, voltage, and filament voltage and current. The vacuum level and gun to work piece distance are also parameters that must be controlled for weld reproducibility. Even for fixed weld piece dimensions, there is not a unique combination of weld settings to accomplish a satisfactory weld. The range of possible satisfactory combinations is further expanded by considering that these welding parameters do not directly translate across electron beam weld machines of different designs or manufacturers. The welding parameters producing an acceptable weld on one machine design may not be optimal or satisfactory for a machine using different components or design.

To fabricate the tuning fork corrosion probe, four (4) electron beam welds 200, 205, 210, 215 are required as shown in FIG. 1. Although it is possible that tips, stems, and diaphragm with its stubs can be fabricated as separate pieces, it is also acceptable to use a pre-fabricated assembling comprising the tip, stems, and diaphragm, in the case where the assembly is prefabricated, either through machining or as a casting, the piece is cut at locations 210 and 215 to enable the insertion of the corrodible stem element 100, 105. The corrodible stem 100 must be welded to the non-corrodible tine tip 110 via weld 200. Weld 205 replicates this weld for the second stem 105 and second tip 115. Preferably, a few preliminary tack welds are made to temporarily connect the stems and tips until the final electron beam weld is performed. The low energy tack welds do not significantly penetrate the surface of the materials nor do they significantly alter the chemical compositions.

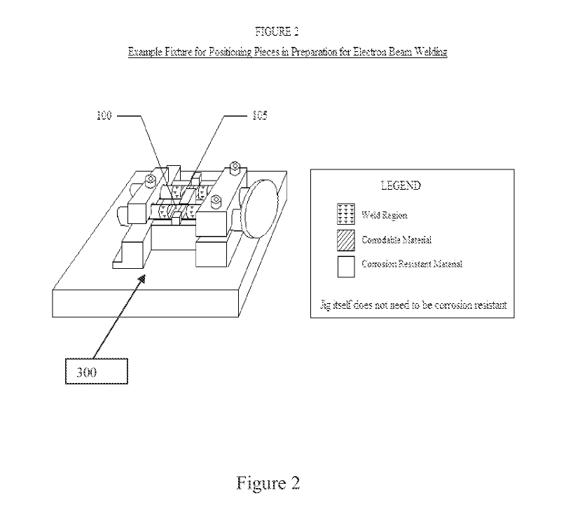

A mechanical jig 300 as shown in FIG. 2 may facilitate fixturing the stem to the tip during the tack welding process. After completing the stern to tip tack welding, the same fixture can be used to tack weld the stems 100, 105 to the stubs 120, 125 of the diaphragm 140. To minimize any discontinuities at the diaphragm, the stubs 120, 125 and the diaphragm 140 are typically machined or cast as a single piece with no welds. After the tack welding secures the pieces, a different jig may be required to complete the electron beam welding. The welding process is facilitated if the final electron beam weld is either weld 210 or 215. There is more space to maneuver the electron beam gun around this weld since it is farther away from the tip than welds 200 or 205.

Completing all of the tack welding prior to the final electron beam welding has the advantage of enabling the entire electron beam welding to be completed during a single vacuum cycle. Completing all of the electron beam welds in a single vacuum cycle reduces the overall fabrication time compared to multiple vacuum cycles. Alternatively, for stub, stem, and tip dimensions that restrict access during the welding process, it may be preferable to complete the tack and final welding for a single stub, stem, and tip before tack welding the second time. This alternative approach requires multiple vacuum cycles but has the advantage of providing better access to the regions that are to be welded.

The diaphragm 140, stubs 120, 125, and tine tips 110, 115 are fabricated from materials that are compatible with the service fluid so that they will not corrode. The material will be dependent upon the service fluid but typical examples include stainless steel, Hastelloy®, Inconel®. The stem 100, 105 material is necessarily non-compatible with the service fluid and will corrode. Examples of stern material include carbon steel and low alloy mild steels. Each combination of materials to be welded will necessitate different electron beam welding parameters.

The dimensions of the pieces to be welded also affects the electron beam welding parameters. Typical dimensions for the stems 100, 105 are diameters ranging from 0.1 to 0.4 inches. The stem length to diameter ratio is not critical but is typically in the range of 2-5.

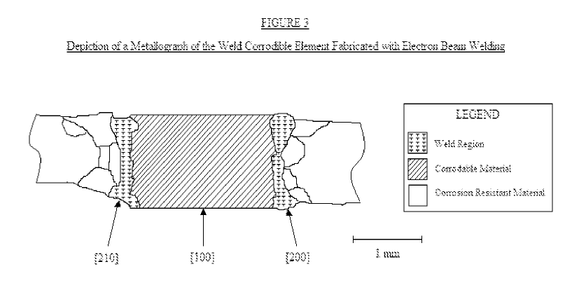

Table 1 summarizes the electron beam parameters for a Hamilton W-3 electron beam welding machine. These welding parameters have been determined for welding American Iron and Steel Institute (AISI) 1018 carbon steel stems 100, 105 to AISI grade 316L stainless steel stubs and tine tips. As confirmed by surface inspection and destructive examination, this set-up provides suitable welding results: full penetration, no surface cracking, while minimizing alloy dilution from the high alloy metals of the stubs 120, 125 and tips 110, 115 to the corrodible low alloy stems 100, 105. Test welds must be fabricated using components with the same dimensions and same metal alloy that will actually be used for fabricating the welds of FIG. 1. The final welds of the test piece are first examined non-destructively for any surface breaking cracks. At a minimum, this examination can be visual using a microscope or can be supplemented using visual dye penetrant materials. A destructive examination is then performed to examine the weld cross-section to confirm satisfactory weld penetration. FIG. 3 presents a depiction of an optical microscope image of a cross-section of welds 200 and 210. This destructive examination confirms the full penetration of the welds. These electron beam parameters can be preserved and used for subsequent fabrications of the metal loss sensor. This weld qualification process may need to be repeated iteratively until a satisfactory combination of electron beam weld parameters have been confirmed for the material compositions and dimensions for the probe being fabricated.

TABLE 1
Electron Beam Welding Parameters to Produce Satisfactory
Welds for the Corrodible Carbon Steel Inserts

| Parameter | Value |
|---|---|
| Vacuum Level | <1 × 10e⁻⁴ mm of Hg |
| Gun to work piece distance | 10.25 inches |
| High Voltage | 140 kV |
| Beam Current (High Limit) | 3.5 mA |
| Beam current fall time | 0.6 seconds |
| Filament current | 2.7 Amps |
| Travel speed | 20 inches/minute |
| Seconds/Revolution | 2 seconds |
| Weld focus | Sharp |

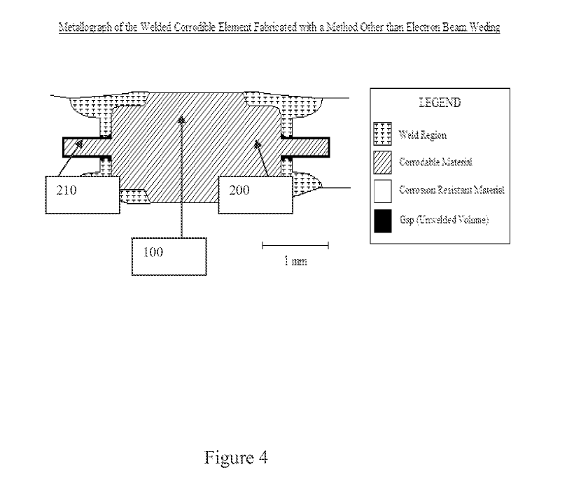

The FIG. 3 shows a schematic of an optical microscope image shows the butt weld geometry for the electron beam welding. Prior to welding, the surfaces were machined flat. In contrast, FIG. 4 shows a schematic of an optical microscope image for making the same joining that did not employ electron beam welding. The alternative methods such as tungsten inert gas (TIG) welding would require excessive heat and filler metal to achieve a full penetration weld. Accordingly, more complex geometry than a simple butt joint was required to make the weld, in FIG. 4, it can be seen that one piece was machined to include a dowel that would mate with a receptor hole in the other piece. The autogenous TIG weld did fuse the shoulder area surrounding the dowel but did not necessarily fuse the dowel to its receptive hole.

As described in AWS C7.1M/C7.1:2004 (recommended Practices for Electron Beam Welding), the Table 1 vacuum condition provides the high vacuum requirement to produce the high quality weldments typically associated with electron beam welding. Moreover, the high voltage prescribed in Table 1 enables the beam width to be highly focused. The highly focused beam minimizes the width of the fusion and heat affected zones.

Any significant change in the material dimensions would require new weld qualification. Likewise, changing the metallurgy on any of the components would require requalification of the welding parameters as described in AWS C7.1.

Consistent with AWSC7.1, a positioning fixture was fabricated to hold the tine tips, stubs, and stems during the electron beam welding process. Each of the welds employed a butt geometry. The fixture holding the pieces was rotated under computer control to maintain a constant speed during the welding process.

Table 2 shows the compositional analysis of the inserted corrodible stern after attachment employing the electron beam parameters shown in Table 1. This analysis has been made at 1 mm intervals starting at the weld and moving along the corrodible stem. The energy-dispersive detector (EDS) feature of a scanning electron microscope made the elemental analysis. The results show that the elemental analysis of the corrodible stub is substantially preserved beyond a distance of 1 mm from each weld.

TABLE 2
Composition of Carbon Steel Insert after
Electron Beam Welding (Note 3)

| | Weld 210 | 1 mm | | | | | | 7 mm | Weld 200 |
|---|---|---|---|---|---|---|---|---|---|
| | Note 1 | Note 2 | 2 mm | 3 mm | 4 mm | 5 mm | 6 mm | Note 2 | Note 1 |
| Si % | 0.9 | 1.0 | 1.0 | 0.9 | 0.8 | 1.1 | 1.3 | 1.3 | 1.0 |
| (note 4) | | | | | | | | | |
| Mo % | 1.9 | 1.4 | 0.4 | 0.5 | 0.4 | 1.0 | 1.0 | 1.8 | 2.3 |
| Cr % | 9.5 | 7.0 | 0.3 | 0.4 | 0.2 | 0.3 | 0.3 | 6.7 | 9.9 |
| Mn % | 0.5 | 0.5 | 1.0 | 1.1 | 0.9 | 1.0 | 1.0 | 0.5 | 0.6 |
| Fe % | 81.6 | 85.9 | 97.2 | 97.2 | 97.6 | 96.5 | 96.3 | 85.4 | 79.6 |
| Ni % | 5.6 | 4.3 | 0.2 | 0.0 | 0.1 | 0.2 | 0.1 | 4.2 | 6.6 |

Notes:
1. Non-corrodible stubs and tips are ASTM 240 grade 316L stainless steel: iron with approximately 16-18% Cr and 10-14% Nickel major alloying elements. Minor alloying with: 2-3% Mo; 2%(max) Mn; 0.75% (max) Si
2. Corrodible stem fabricated from AISI 1018 steel (AISI—American Iron and Steel Institute). Iron with approximately Mn 0.6-0.9%; C 0.15-0.2%; Si 0.15-0.3% alloying elements
3. The elemental analysis was measured and averaged over a 1 mm wide linear dimension.
4. The energy-dispersive detector (EDS) feature of a scanning electron microscope is not reliable for making a quantitative measure of light elements like silicon.

To maintain the corrosion properties of the carbon steel stems 100, 105, it is desirable to minimize the concentration of the major alloying elements of the non-corrodible materials 120, 110, 125, 115, 140 that could contaminate the carbon steel. For the particular case of carbon steel stems, maintaining the center third of stems 100, 105 with chromium content less than 0.5% and nickel content less than 0.2% is satisfactory. These levels of alloying elements will not significantly alter the corrosion properties of the carbon steel for sulfidation or naphthenic acid corrosion. The level of acceptable alloying contamination for specific corrosive environments should be assessed on a case by case basis.

For cases where the stem material is a low carbon steel alloy (carbon alloying in the range of approximately 0.05-0.15%) with other major alloying elements such as nickel or chromium, the welding process should not allow an increase of those elements beyond 10% of their nominal specified content. For example, ASTM specification SA-335 allows a range of 4-6% chromium for grade P5 material. The electron beam welding process should not increase the chromium content for a stem material of grade P5 above 6.5%.

The most common monitoring objective is for the corrosion probe metallurgy to respond in a manner similar to the pipe and/or vessel where the probe is installed. If the corrodible stem element becomes compromised by welding during the fabrication process, the probe will not provide the expected response to metal loss of pipe or vessel material. It has been observed that weld methods such as TIG have 3 primary disadvantages for this application. The first is that filler metal (when used) spreads beyond the weld providing a thin metal alloy layer on the stem reducing its corrodibility. The second is that the wider heat affected zone (HAZ) compromises the mechanical properties of the corrodible stem. And the third is that incomplete fusion (incomplete penetration) may result with methods where heat must be limited in order to maintain an acceptable width of the heat affected zone.

Employing welding methods that minimize contamination of the stem material by alloying elements from the stubs or paddles may also be beneficial in cases where it is desired to measure erosion. Minimizing the width of the fusion and heat affected zone with electron beam welding maintains the characteristics of the stern material that could affect erosion.

It is understood by those skilled in the art that other corrosion probe designs can also benefit from welding techniques that minimize any compositional or mechanical compromise to the corrodible element. An electrical resistance corrosion probe design would also benefit from welding procedures that do not employ conductive melting to achieve heating. In an electrical resistance corrosion probe, the corrodible wire must be attached to the noncorrodible electrical terminals. Attachment methods such as electron beam welding are well-suited for achieving that fabrication.

What is claimed is:

1. A method for welding a first material that is affected by a corrosive environment to a second material that is not affected by a corrosive environment such that the step of welding does not change the affect that the corrosive environment has on the first material and the second material.

2. The method according to claim 1, wherein said step of welding includes electron beam welding.

3. The method according to claim 1, wherein the step of welding is used to form a metal loss probe.

4. The method according to claim 3, wherein the metal loss probe is a mechanical oscillator.

5. The method according to claim 4, wherein the mechanical oscillator is a tuning fork.

6. The method according to claim 1, wherein the first material is a low alloy mild steel and the second material is stainless steel.

7. The method according to claim 3, wherein the contamination concentration of the first material is limited to 10% of the concentration of the major alloying elements of the second material.

8. The method according to claim 7, wherein the step of welding fabricates a full penetration weld.

9. A mechanical oscillator metal loss sensor for use in a corrosive or erosive environment including two materials that corrode differently wherein one material is not affected by the corrosive or erosive environment and the second material is affected by the environment such that the two materials are welded together so that the welding leaves unaltered the effect that the environment has on the first and second materials.

10. The mechanical oscillator according to claim 9, wherein said welding includes electron beam welding.

11. The mechanical oscillator according to claim 9, wherein one material corrodes and the other material does not corrode.

12. The mechanical oscillator according to claim 11, wherein the material that does not corrode is stainless steel and the material that does not corrode is carbon steel.
